(19) United States
(12) Patent Application Publication
(10) Pub. No.: US 2025/0078193 A1
(43) Pub. Date: Mar. 6, 2025

(54) METHOD AND SYSTEM FOR COURSE REGISTRATION IN A LEARNING MANAGEMENT SYSTEM

(71) Applicant: D2L Corporation, Kitchener (CA)

(72) Inventor: Jeremy AUGER, Kitchener (CA)

(21) Appl. No.: 18/821,232

(22) Filed: Aug. 30, 2024

Related U.S. Application Data
(60) Provisional application No. 63/580,176, filed on Sep. 1, 2023.

(51) Int. Cl. G06Q 50/20; G06Q 50/00

(52) U.S. Cl. CPC G06Q 50/2053; G06Q 50/01

(57) ABSTRACT

A method and system for course registration. The method including: monitoring for a request to access a course registration system by a user; upon receipt of a request, determining if the user is logged in: if so, retrieving internal information on the user; if not, retrieving external information on the user; parsing the internal and/or external user information; determining a set of courses based on the parsed user information; displaying the set of courses and one or more informational elements for one or more courses based on the parsed user information; monitoring for a user selection from the displayed set of courses or one or more informational elements; and upon receiving a user selection, processing the user selection. The system for course registration including: a memory storing computer readable instructions; a processor which executes the computer readable instructions to provide a course review module configured to perform the method.

### FIELD

The present disclosure relates generally to course registration in a learning management system. More particularly, the present disclosure relates to a method and system for intelligent promotion of course registration.

### BACKGROUND

Learning management systems (“LMS”) are becoming more popular for delivery of educational material in many different situations, whether in conventional areas like public/private educational institutions all the way through to corporations providing internal training to their employees. Some LMSs merely track student registration and progress while others deliver course content and materials directly to students.

With the rapid increase of LMSs and the organizations that use them and provide educational content, there is also an increase in the number and variety of courses being offered and available to learners. A learner has a wide variety of options to choose from and it is important for the learner to be able to find and choose a course in an expeditious manner. As such, there is a need for an improved method for leaners to register for a course in a learning management system.

The above information is presented as background information only to assist with an understanding of the present disclosure. No determination has been made, and no assertion is made, as to whether any of the above might be applicable as prior art with regard to the present disclosure.

### SUMMARY

In a first aspect, there is provided a method for course registration, the method including: monitoring for a request to access a course registration system by a user; upon receipt of a request, displaying a set of available courses; determining if a user is logged in and, if so, retrieving internal information on the user; if not, retrieving external information on the user; parsing the information received based on the set of courses displayed; displaying one or more informational elements for one or more courses in the set of available courses based on the parsed information; monitoring for a user selection from the displayed courses or informational elements; and upon receiving a user selection, processing the user selection.

In some cases, the displaying may include: presenting a first informational element for courses that can be registered without further information; and presenting a second informational element for courses that require additional information before registration.

In some cases, the additional information may include at least one of: an approval from an approver; and evidence of completion of a pre-requisite.

In some cases, the processing the user selection may include at least one of: sending a communication seeking an approval from an approver; and providing an upload screen to allow the user to upload evidence of completion of a pre-requisite.

In another aspect herein, there is provided a system for course registration, the system including: a learning management system comprising: a processor; a memory; a course registration module configured to use the processor to access the memory and execute computer readable instructions that cause the processor to: monitor for a request to access a course registration system; upon receipt of a request, display a set of available courses; determine if a user is logged in and, if so, retrieve internal information on the user; if not, retrieve external information on the user; display badges for one or more courses in the set of available courses based on the information retrieved; monitor for a user selection from the displayed courses or badges; upon receiving a user selection, process the user selection.

According to another aspect herein, there is provided a method for course registration, the method including: monitoring for a request to access a course registration system by a user; upon receipt of a request, determining if the user is logged in: if so, retrieving internal information on the user; if not, retrieving external information on the user; parsing the internal and/or external user information; determining a set of courses based on the parsed user information; displaying the set of courses and one or more informational elements for one or more courses based on the parsed user information; monitoring for a user selection from the displayed set of courses or one or more informational elements; and upon receiving a user selection, processing the user selection.

In some cases, the retrieving internal user information may include searching for at least one of enrolled program, courses taken, marks received, friend groups, member of a group or sub-group authorized to take the course.

In some cases, the retrieving external user information may include: determining if external user information was provided when the user accessed the course registration system; if so, searching social media based on the external user information for additional external user information; if not, displaying a predetermined set of courses and requesting external user information from the user.

In some cases, the method may further include, if the user is logged in, retrieving external information on the user.

In some cases, the one or more informational elements may include at least one of: a first informational element for a course that can be registered without further information; and a second informational element for a course that requires additional information before registration.

In this case, the additional information may include at least one of: an approval

from an approver; evidence of completion of a pre-requisite; and evidence of an achieved skill level.

Alternatively or also, in this case, the one or more informational elements may further include at least one of: friends of the user who have taken the course; careers available to those that take the course; and salary ranges for the careers.

In some cases, the processing the user selection may include at least one of: registering the user in a selected course; sending a communication seeking an approval from an approver; and providing an upload screen to allow the user to upload evidence of completion of a pre-requisite.

According to another aspect herein, there is provided a system for course registration, the system including: a memory storing computer readable instructions; a processor which executes the computer readable instructions to provide a course review module configured to: monitor for a request to access a course registration system; upon receipt of a request, determine if a user is logged in: if so, retrieve internal information on the user; if not, retrieve external information on the user; parse the internal or external user information; determine a set of courses based on the parsed user information; display the set of courses and one or more informational elements for one or more courses based on the parsed user information; monitor for a user selection from the displayed set of courses or one or more informational elements; and, upon receiving a user selection, process the user selection.

In some cases, the retrieve internal user information may include search for at

least one of enrolled program, courses taken, marks received, friend groups, member of a group or sub-group authorized to take the course.

In some cases, the retrieve external user information may include: determine if external user information was provided when the user accessed the course registration system; if so, search social media based on the external user information for additional external user information; and, if not, display a predetermined set of courses and requesting external user information from the user.

In some cases, the course review module may further include, if the user is logged in, retrieve external information on the user.

In some cases, the one or more informational elements may include at least one of: a first informational element for a course that can be registered without further information; and a second informational element for a course that requires additional information before registration. In this case, the additional information may include at least one of: an approval from an approver; evidence of completion of a pre-requisite; and evidence of an achieved skill level. Alternatively or also, in this case, the one or more informational elements may further include at least one of: friends of the user who have taken the course; careers available to those that take the course; and salary ranges for the careers.

In some cases, the process the user selection may include at least one of: register the user in a selected course; send a communication seeking an approval from an approver; and provide an upload screen to allow the user to upload evidence of completion of a pre-requisite.

Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 illustrates an example of a learning management system;

FIG. 2 illustrates an example of a computing device for communication with the learning management system of FIG. 1;

FIG. 3 illustrates an example of a course registration module according to an embodiment herein;

FIG. 4 illustrates an example display by a course registration module according to an embodiment herein; and

FIG. 5 is a flowchart illustrating a method for course registration according to an embodiment herein.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not intended to be limited to the bibliographical meanings, but, are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides a method and system for course registration. In particular, the embodiments of the system and method detailed herein provide for a method and system for course registration that includes access to promotional material, checking of pre-requisites/approval, and immediate registration for those with pre-requisites/approval.

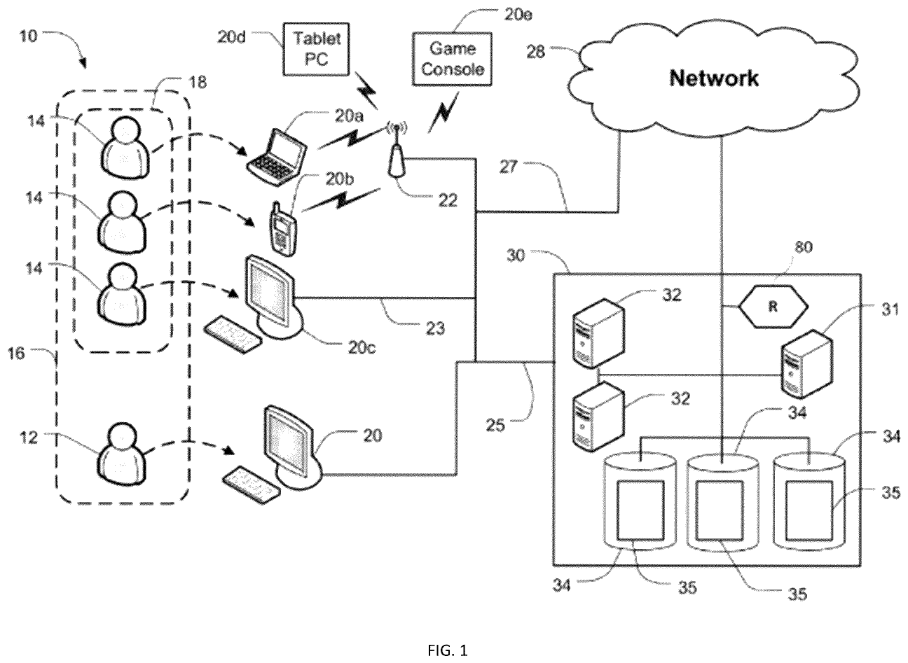

FIG. 1 illustrates an example embodiment of a learning management system 10 according to one embodiment. The learning management system 10 includes an educational service provider system 30, which can be accessed by various users 12, 14 via computer networks.

The users 12, 14 communicate with the educational service provider system 30 either directly or indirectly using any suitable computing device 20, such as, for example a desktop computer that has at least one input device (e.g., a keyboard and a mouse) and at least one output device (e.g., a display screen and speakers). Other examples of the computing device may include: a laptop 20a wirelessly coupled to an access point 22 (e.g., a wireless router, a cellular communications tower, etc.), a wirelessly enabled mobile device, smart phone or the like 20b, a terminal 20c over a wired connection 23, a tablet computer 20d, or a game console 20e over a wireless connection. The computing devices 20 may be connected to the educational service provider system 30 via any suitable communications channel. For example, the computing devices 20 may communicate to the educational service provider system 30 directly through a LAN/intranet or wireless network via a data connection 25, or using an external network, such as, for example, the Internet 28 over a data connection 27.

In some cases, one or more of the users 12 and 14 may be required to authenticate their identities in order to communicate with the educational service provider system 30. For example, the users 12 and 14 may be required to input a login name and/or a password or otherwise identify themselves to gain access to the learning management system 10. In other cases, one or more users (e.g., “guest” users) may be able to access the learning management system 10 without authentication. Such guest users may be provided with limited access, such as the ability to review only one or a few components of the course, for example, to decide whether they would like to enroll in a particular course.

The educational service provider system 30 generally includes a number of components for facilitating the provision of electronic learning services. For example, the educational service provider system 30 generally includes one or more processing devices 32 (e.g., servers), each having one or more processors. The processing devices 32 are configured to send information (e.g., HTML or other data) to be displayed on one or more computing devices 20, 20a, 20b and/or 20c to facilitate social electronic learning (e.g., course information). In some cases, the processing device 32 may be a computing device 20 (e.g., a laptop or a personal computer).

The educational service provider system 30 also generally includes one or more data storage devices 34 (e.g., memory, etc.) that are in communication with the processing devices 32, and could include a relational database (such as an SQL database), or other suitable data storage devices. The data storage devices 34 are configured to host data 35 relating to the courses offered by the service provider.

For example, the data 35 can include course frameworks, educational materials to be consumed by the users 14, historical records about assessments or grades of users 14 or assignments completed by the users 14, as well as various other information.

The data storage devices 34 may also store authorization criteria that define which actions may be taken by the users 12 and 14. In some cases, the authorization criteria may include at least one security profile associated with at least one role. For example, one role could be defined for users who are primarily responsible for developing an educational course, teaching it, and assessing work product from students of the course. Users with such a role may have a security profile that allows them to configure various components of the course, to post assignments, to add assessments, to evaluate performance, and so on.

In some cases, some of the authorization criteria may be defined by specific users 40 who may or may not be part of the educational community 16. For example, users 40 may be permitted to administer and/or define global configuration profiles for the learning management system 10, define roles within the learning management system 10, set security profiles associated with the roles, and assign roles to particular users 12, 14 who use the learning management system 10. In some cases, the users 40 may use another computing device (e.g., a desktop computer 42) to accomplish these tasks.

The data storage devices 34 may also be configured to store other information, such as personal information about the users 12, 14 of the learning management system 10, information about which courses the users 14 are enrolled in, roles to which the users 12 and 14 are assigned, particular interests of the users 12,14, and historical information about the performance of the users 12, 14.

The processing devices 32 and data storage devices 34 may also provide other electronic learning management tools (e.g., allowing users to add and drop courses, communicate with other users using chat software, etc.), and/or may be in communication with one or more other vendors that provide various tools.

In some cases, the educational service provider system 30 may also have one or more backup servers 31 that may duplicate some or all of the data 35 stored on the data storage devices 34. The backup servers 31 may be desirable for disaster recovery to prevent undesired data loss in the event of an electrical outage, fire, flood or theft, for example. The backup servers 31 could be located at a remote storage location and the service provider system 30 could connect to the backup server 31 using a secure communications protocol to ensure that the confidentiality of the data 35 is maintained.

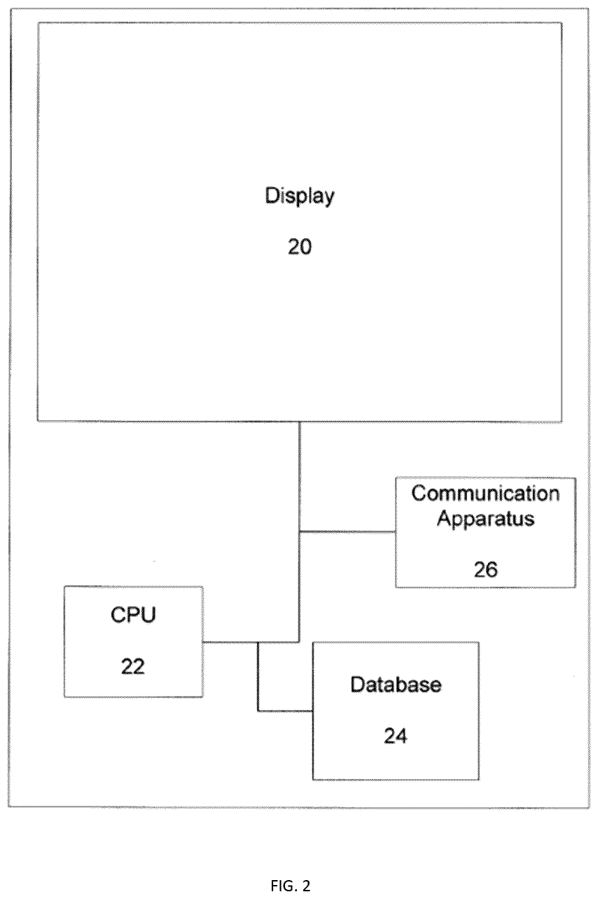

FIG. 2 is a schematic diagram of an example computing device 20, in this case, a mobile computing device, which communicates wirelessly. As shown, the computing device 20 comprises a processor 22, a memory 24, a communication apparatus 26, a display 28, and an input apparatus 29. A user 12, 14, uses the functions of the computing device 20 to communicate with the educational service provider system 30 as described herein.

Generally speaking, the users 12, 14 can use the learning management system 10 to communicate with the educational service provider system 30 to participate in, create, and consume electronic learning services, including enrolling in and participating in various educational courses. In some cases, the educational service provider system 30 may be part of or associated with a traditional “bricks and mortar” educational institution (e.g., an elementary school, a high school, a university or a college), another entity that provides educational services (e.g., an online university, a company that specializes in offering training courses, or an organization that has a training department), or an independent service provider (e.g., for providing individual electronic learning).

It should be understood that a “course” is not necessarily limited to formal courses offered by formal educational institutions. The course may generally include any form of learning instruction offered by an entity of any type. For example, the course may be a training seminar at a company for a small group of employees, a professional certification program with a larger number of intended participants (e.g., PMP, CMA, etc.), and so on.

It should also be understood that users 12, 14 may fall into various categories, including students, instructors, guests, or the like. Further, one or more educational groups can be defined that involve one or more of the users 12, 14. For example, as shown in FIG. 1, the users 12, 14 may be grouped together in an educational group 16 representative of a particular course (e.g., History 101, French 254), in which the first user 12 is an “instructor” and is responsible for providing the course (e.g., organizing lectures, preparing assignments, creating educational content, etc.), while the other users 14 are “learners” or “students” that consume the course content (e.g., the users 14 are enrolled in the course to learn the course content). In some cases, the users 12, 14 may be associated with more than one educational group. For instance, the users 14 may be enrolled in more than one course, while the user 12 may be enrolled in a course and also responsible for teaching a course (which is common for example for graduate students).

In some cases, educational sub-groups may also be defined. For example, in FIG. 1, some users 14 are shown as part of an educational sub-group 18. The sub-group 18 may be defined in relation to a particular project or assignment (e.g., sub-group 18 may be a lab group) or based on other criteria. In some cases, due to the nature of electronic learning, the users 14 in a particular sub-group 18 need not physically meet but may collaborate together using various tools provided by the educational service provider system 30.

In some cases, the groups 16 and sub-groups 18 could include users 12, 14 that share common interests (e.g., interests in a particular sport), that participate in common activities (e.g., users that are members of a choir or a club), and/or have similar attributes (e.g. users that are male, users under twenty-one years of age, etc.).

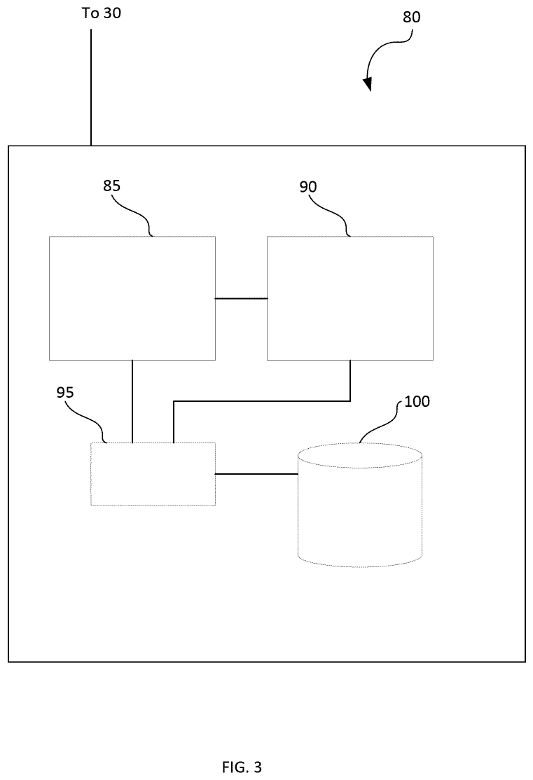

As shown in FIG. 1, the educational service provider system 30 can include a course registration module 80, which provides information on courses and allows for registration. FIG. 3 illustrates a block diagram of the course registration module 80 according to one embodiment. In this embodiment, the course registration module 80 is operable to communicate with the user 14 via the learning management system 10 using, for example, the computing device 20. It will be understood that the course registration module 80 may be accessed by users outside of the LMS 10 and, in some cases, the course registration module 80 may be separate from the educational service provider system 30.

In this embodiment, the course registration module 80 includes a course review module 85 and a course display module 90. The course registration module 80 may include its own processor 95 and memory storage/database 100 or may rely on those available through the educational service provider system 30, external providers, or the like.

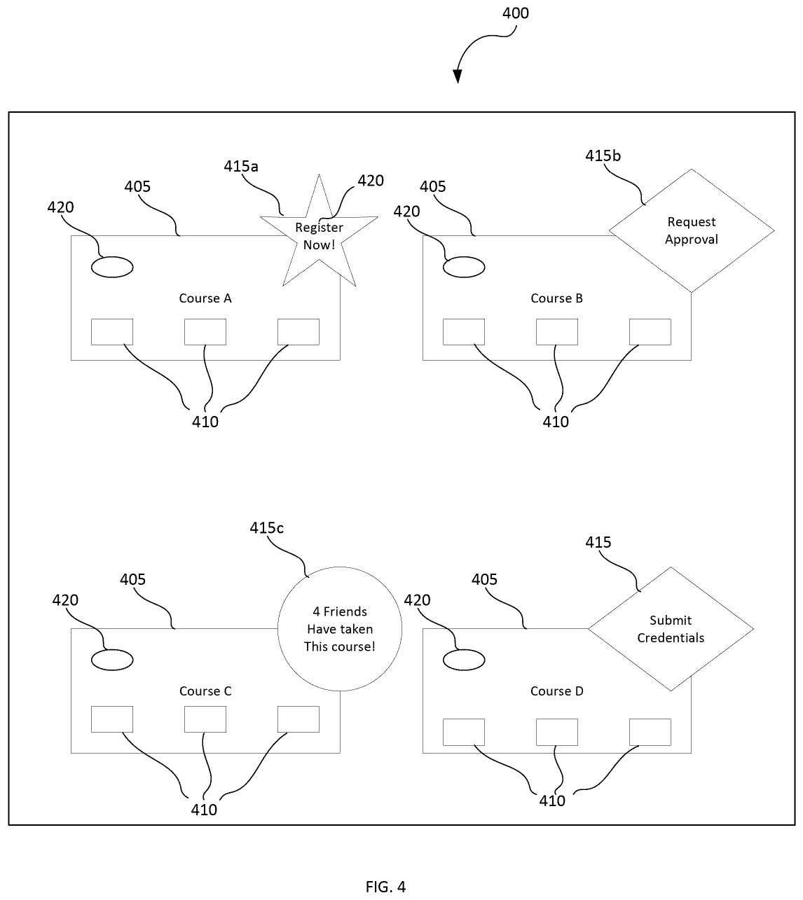

When a user desires to select/register for a course, the course registration module 80 can be initiated to allow a user to search for courses. When the course registration module 80 is accessed, the course registration module 80 may display, via the course display module 90, a predetermined selection of courses available. Alternatively, when accessed, the course review module 85 may determine if a user is logged in or not and, if logged in, acquire user information associated with the user from, for example, an connected (internal) database to determine internal user information that can help determine the courses to be displayed or the type of courses to be displayed. The database may be remote or local, such as via the course review module 85 or via the educational service provider system 30. If the user is not logged in, the course review module 85 can use any social media data, meta-data, cookies or the like that may be available about the user to access information about the user from an external data source or database (external user information). For example, if a user is directed to the course registration module 80 via a social network site, the course review module may be able to access information from that social media site about the user via, for example, searches on or cookies left or created in relation to the social media site. It will be understood that the course review module 85 may also access social media sites, metadata, cookies and the like for logged-in users as well. The internal and external data can be used to determine the courses or type of courses to be displayed. The course review module 85 may then either update the displayed courses or newly display courses, via the course display module 90, to the user based on the user information acquired/retrieved. FIG. 4 illustrates a schematic diagram of an embodiment of a course display 400 at this stage.

As an example of the user information (internal/external) that may be obtained, the course review module 85 can review the user's records in the educational service provider system 30 for a logged in user to determine various characteristics of the user such as: enrolled program, courses taken, marks in courses taken, if a pre-requisite course has been completed, if a required mark was obtain in a pre-requisite course, if an approval from an instructor or other approver has been provided, if the learner is a member of a group or sub-group authorized to take the course, or other indicators to determine the courses to display. As another example, the course review module 85 can review a user's social media accounts/connections for educational and/or career related information to determine the type of course that may be of interest. Educational and career information is available via, for example, LinkedIn™ or the like. For example, a next step in the user's career or education path. If the user has a qualification at a particular level, a course directed at a next level can be displayed.

As illustrated in FIG. 4, the course review module 85 can then use the acquired user information to determine the courses 405 displayed to the user via the course display module 90 and also to display one or more informational elements 410 for the courses displayed. The informational elements 410 may include text, graphics, hyperlinks, and the like. In some cases, the course may also include a badge 415 or the like (which may also be considered an informational element 10) that is associated with the course, a related program, or the like. In some cases, the course review module 85 can use the user information to determine if the user meets the requirements for the course and, in this case, the badge 415 may display a “Register Now” display/button 420 or the like that will allow the user to register for the course immediately, i.e. without further input, information, other prerequisites, or the like, by clicking on the “Register Now” button. If the user has not satisfied all requirements, the badge may display information about what requirements might be needed and possibly include a link that would allow the user to work on those requirements. For example, the badge might have a link/recommendation that the user seek approval from an instructor, a manager, or the like depending on the type of course/environment. In some cases, the link may provide for a request to be sent to an instructor via the educational service provider system 30. It is intended that the automatic display of the “register now” button and/or the links to allow the user to satisfy the requirements may lead to higher registration rates.

As noted above, the course review module 85 can obtain user information, particularly when a user is logged into a learning management system 10. As noted, in some cases, the course review module 85 can obtain user information from external sources using, for example, meta-data, cookies or the like that may be provided when a user accesses the learning management system 10. For example, if a user is directed to the course selection website by a social media site such as for example, Facebook™ or LinkedIn™, meta-data may be provided that will allow the course review module 85 to analyze user information (using, for example, artificial intelligence (AI), machine learning, language-processing techniques, or the like, on the user's social media site) to identify relevant background or qualifications of the user. For instance, where a user's “friends” (either self-identified or inferred friends) have already taken a particular course, then the course review module 85 may indicate some form of encouragement to the user. Similarly, the course review module 85 may review a user's educational history to determine that the user already has a degree/qualification that may be a pre-requisite for a particular course that could be shown with a “register now” indication. If the user is not logged in and there is no external user information readily available, the course review module 85 may query the user for additional external user information by asking predetermined or generated questions such as “what is your interest?”, “what is your name?”, or the like.

As illustrated in the example display 400 of FIG. 4, courses and course information can be presented as a webpage displayed on a computing device 20, for example, via a browser or client software running on the computing device 20, or in any other suitable manner. As shown in this example, the various courses 405 are displayed and the course review module 85 has generated badges 415 based on user information associated with a user. Each badge 415 may have a different shape, color, or other characteristic to differentiate each badge from another type of badge. In this particular example, a star badge 415a can indicate a “register now” link 420 or the like while a diamond badge 415b can indicate a step that the user can take or verify to allow the course to be taken. As noted, in some examples, the diamond badge 415b can include a link that allows the user to initiate the process to seek approval or the like. As a further example, a circular band 415c may include information, such as friends that have taken the course, careers available to those that take the course, salary ranges for users who have completed the course or entered a career based on the course, and the like, to encourage the user to register and/or look into the course further.

As shown in FIG. 4, each course may include links 410 to further information about the course such as course description, times offered, who is teaching the course, credits, pre-requisites, and so on. In some cases, this further information may be available by hovering over the course itself or a relevant link.

In some cases, the user may also have the ability to learn more about the user information provided in a badge 415. For example, the user may be able to mouse over a badge or access a hyperlink or the like to see further detail on the information in the badge 415. For example, the badge 415 may provide further detail about the friends that have taken the course, about the approvals needed, about credentials needed, or the like and may also include further detail indicating where the information was generated.

Further, in some embodiments, a course 405 or a badge 415 may also include a handling link 420 to remove the course from the group of courses to be displayed. In this case, a user's decision not to review a course may be saved for the future or the user may be presented with options such as “save for future”, “don't show again” or the like. This will allow a user to structure the types of courses that will be displayed.

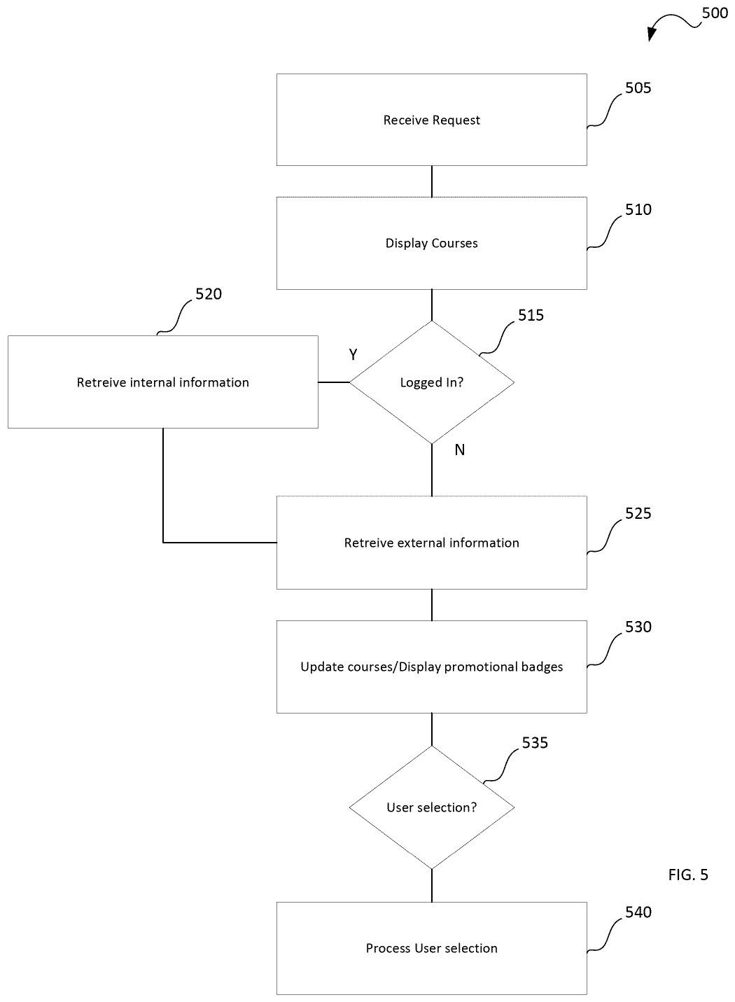

FIG. 5 is a flowchart illustrating a method 500 for course registration according to an embodiment. The method 500 starts when the system (e.g. the course registration module 80/course review module 85) receives a request to begin at 505. The system may then begin displaying available courses at 510. The display of available courses may be based on predetermined courses or an appropriate selection algorithm. In some cases, this display may be deferred until after information is gathered in the next stages. The system then determines if the user is logged in or not at 515. The system can continue to check for login status while the method is operating. If the user is logged in, user information can be retrieved from an internal source at 520, such as, for example, the learning management system 10, (an internal source and internal user information) and the courses or types of courses displayed may be updated based on the retrieved internal user information. If the user is not logged in or following checking for internal information, the system may seek external information at 525 as noted above and the courses or types of courses displayed may be updated based on the retrieved external user information at 530. After retrieving internal and/or external user information, promotional badges may be displayed based on the user information retrieved at 530.

The system then waits for a user selection/interaction at 535. If the user makes a selection/interaction, the system then processes that selection at 540. As described above, the badges may provide an option to “register now”, to take an action toward registration, to provide more information, or the like. For example, if the user is logged in and selects “register now”, the system can immediately register the user for the course or, if the user is not logged in, the system can provide a screen to take in any additional information needed from the user that was not available from the external information, if available.

In the preceding description, for purposes of explanation, numerous details are set forth in order to provide a thorough understanding of the embodiments. However, it will be apparent to one skilled in the art that these specific details may not be required. In other instances, structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for course registration, the method comprising:
monitoring for a request to access a course registration system by a user;
upon receipt of a request, determining if the user is logged in:
if so, retrieving internal information on the user;
if not, retrieving external information on the user;
parsing the internal and/or external user information;
determining a set of courses based on the parsed user information;
displaying the set of courses and one or more informational elements for one or more courses based on the parsed user information;
monitoring for a user selection from the displayed set of courses or one or more informational elements; and,
upon receiving a user selection, processing the user selection.

2. A method according to claim 1, wherein the retrieving internal user information comprises searching for at least one of enrolled program, courses taken, marks received, friend groups, member of a group or sub-group authorized to take the course.

3. A method according to claim 1, wherein the retrieving external user information comprises:
determining if external user information was provided when the user accessed the course registration system;
if so, searching social media based on the external user information for additional external user information;
if not, displaying a predetermined set of courses and requesting external user information from the user.

4. A method according to claim 1, further comprising, if the user is logged in, retrieving external information on the user.

5. A method according to claim 1, wherein the one or more informational elements comprise at least one of:
a first informational element for a course that can be registered without further information; and
a second informational element for a course that requires additional information before registration.

6. A method according to claim 5, wherein the additional information comprises at least one of:
an approval from an approver;
evidence of completion of a pre-requisite; and
evidence of an achieved skill level.

7. A method according to claim 5, wherein the one or more informational elements further comprise at least one of:
friends of the user who have taken the course;
careers available to those that take the course; and
salary ranges for the careers.

8. A method according to claim 1, wherein the processing the user selection comprises at least one of:
registering the user in a selected course;
sending a communication seeking an approval from an approver; and
providing an upload screen to allow the user to upload evidence of completion of a pre-requisite.

9. A system for course registration, the system comprising:
a memory storing computer readable instructions;
a processor which executes the computer readable instructions to provide a course registration module configured to:
monitor for a request to access a course registration system;
upon receipt of a request, determine if a user is logged in
if so, retrieve internal information on the user;
if not, retrieve external information on the user;
parse the internal or external user information;
determine a set of courses based on the parsed user information;
display the set of courses and one or more informational elements for one or more courses based on the parsed user information;
monitor for a user selection from the displayed set of courses or one or more informational elements; and,
upon receiving a user selection, process the user selection.

10. A system according to claim 9, wherein the retrieve internal user information comprises search for at least one of enrolled program, courses taken, marks received, friend groups, member of a group or sub-group authorized to take the course.

11. A system according to claim 9, wherein the retrieve external user information comprises:
determine if external user information was provided when the user accessed the course registration system;
if so, search social media based on the external user information for additional external user information;
if not, display a predetermined set of courses and requesting external user information from the user.

12. A system according to claim 9, further comprising, if the user is logged in, retrieve external information on the user.

13. A system according to claim 9, wherein the one or more informational elements comprise at least one of:
a first informational element for a course that can be registered without further information; and
a second informational element for a course that requires additional information before registration.

14. A system according to claim 13, wherein the additional information comprises at least one of:
an approval from an approver;
evidence of completion of a pre-requisite; and
evidence of an achieved skill level.

15. A system according to claim 13, wherein the one or more informational elements further comprise at least one of:
friends of the user who have taken the course;
careers available to those that take the course; and
salary ranges for the careers.

16. A system according to claim 9, wherein the process the user selection comprises at least one of:
register the user in a selected course;
send a communication seeking an approval from an approver; and
provide an upload screen to allow the user to upload evidence of completion of a pre-requisite.
